(19) United States
(12) Patent Application Publication
(10) Pub. No.: US 2022/0155868 A1
(43) Pub. Date: May 19, 2022

(54) SYSTEM TO REMIND PEOPLE TO TAKE ACTION TO ACHIEVE THEIR GOALS AND FORM NEW HABITS BY USING THE POWER OF THEIR FOCUS AND REPETITION

(71) Applicant: Paul Andrew Musgrove, Leeds (GB)

(72) Inventor: Paul Andrew Musgrove, Leeds (GB)

(21) Appl. No.: 17/099,788

(22) Filed: Nov. 17, 2020

(51) Int. Cl. G06F 3/01; G06F 1/16; G08B 21/24

(52) U.S. Cl. CPC G06F 3/016; G08B 21/24; G06F 1/163

(57) ABSTRACT

A system to remind people to take action to achieve their goals and form new habits by using the power of their focus and repetition. The system consists of a wearable device and a method. The wearable device is to send preselected interval vibrated reminders to connect to an action to achieve a specific goal. The method comprising of four steps, where a user in the first step chooses one goal to help the mind focus on it, then in the second step the user selects a time interval from the wearable device, then in the third step, the user mentally connect the vibrated reminder he receives from the wearable device to an action he must do to achieve the goal, then in the fourth step the user will use focus-repetition and meditation to put attention on in his goal to summon all the mind abilities to reach this goal.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present invention relates generally to a reminder system, In particular, the present invention relates to a system comprising a wearable device to send preselected interval vibrated reminders to connect to an action, and a method using the power of focus and repetition to achieve goals and form new habits

### Description of the Related Art

In the modern era, life became very complicated and people became very busy with daily life details, the fact makes it difficult for them to remember their goals they want to achieve. The only way a user can use to remind him to achieve a specific goal or task is the smart mobile phone or smart watch as he wears them all the time, but the problem is everyday people receive many notifications on their mobile phones and smart watchs, the fact makes it very difficult for everyone to set a mobile phone or smart watch to remind him for a specific goal he wants to achieve. Even if someone sets his smartphone or smart watch to remind him for a specific goal or task, often he will not pay any attention to the goal notification either because he will not focus on it as he receives many notifications because the smart watch or smart phone designed for many tasks like making calls, check emails, playing games, listen to music, watching videos, checking calendar, tracking activities and fitness, social media, watching photos, buying from online store, working online, using recipes and food apps, using online banking apps, surfing internet, using calculators, using transportation apps and many other tasks a user can do using his smart mobile phone or watch, or because the notifications of the specific goals or tasks will be very similar to the notifications of the other tasks of the smart phone or watch that is making difficult for the brain to focus on a notification for a specific goal or task. Even if a user sets the mobile phone or smart watch to make a unique notification for a specific task or goal, he often will ignore it as he will need some time to open his mobile phone or smart watch to check the notification to remember what this notification is for.

On the other side, it is so difficult to create good habits and reach goals as it is hard to keep our goals at the forefront of our mind, so we find it difficult to feel motivated to take action toward achieving our goals or forming new habits.

### BRIEF SUMMARY OF THE INVENTION

In one aspect, the present invention proposes a system comprising a wearable device and a method for reminding people to achieve goals and form new habits only by making customized vibrations to make conditional link between a specific customized vibration generated by the wearable device and a specific goal or task using the power of focus and repetition.

In another aspect, the wearable device of the present invention gives a vibration reminder that focuses your mind and keeps your goal in your conscious awareness and prompts to take action.

In yet another aspect he system of the present invention will help people focus on their goals only without getting distracted.

In yet another aspect, the system of the present invention uses the power of focus and repetition to make a conditional link between a specific customized vibration generated by the wearable device and a specific goal to keep it in the conscious awareness compelling to take an action until getting the results wanted.

In yet another aspect, the wearable device of the present invention vibrates throughout the day to remind a user to focus on reaching goals.

In yet another aspect, the wearable device of the present invention is not annoying as it vibrates for 4.5 seconds and does not need to be pressed.

In yet another aspect, the wearable device of the present invention has no apps or distractions like mobile phones and smart watches.

In yet another aspect, the wearable device of the present invention has no batteries, but it has a chargeable battery that can be charged by USB cable.

In yet another aspect, the wearable device of the present invention has not a clock time to prevent distracting the users.

In yet another aspect, the system of the present invention is to master a user's mind and convert a user's knowledge and plans into actions and habits.

In yet another aspect, the system of the present invention use focus-repetition with a physical action by sending to a user a steady stream of reminders flooding through his mind to achieve a specific goal leading him to take an action, and it floods the user subconscious mind with intention, so through repetition, the goal will become a muscle memory habit.

In yet another aspect, the system of the present invention used by meditate where when a user receives the vibrated reminders, the user takes a deep breath, observes his thoughts, puts attention on in his inner body and his goal to make the user conscious mind receives a message that specified goal is a top priority and a user must do everything to reach it.

In yet another aspect, the system of the present invention keeps a user motivated to help him achieve the goals he started and planned.

In yet another aspect, the system of the present invention helps focus on goals as everyday we store many thoughts in our mind that make it difficult to keep our goals in the same priority.

In yet another aspect, the system of the present invention helps to keep the feeling you had when you planned to achieve a goal, at the front of your mind, in order to keep you on track till you achieve the goal.

### DESCRIPTION OF THE DRAWINGS

An example of the invention will now be described by referring to the accompanying drawings:

FIG. 1 is a perspective top side view of the wearable device;

FIG. 2 is a perspective top side view of the wearable device;

FIG. 3 is a perspective top side view of the wearable device showing battery percentage;

FIG. 4 is a perspective top side view of the wearable device showing interval;

FIG. 5 is a perspective bottom side view of the wearable device.

FIG. 6 is a perspective bottom side view of the wearable device showing the head and display.

FIG. 7 is a perspective bottom side view of the head.

FIG. 8 is a perspective bottom side view of the head.

FIG. 9 is a side view of the wearable device.

FIG. 10 is a top view of the wearable device where someone sets it.

FIG. 11 is a top view of the wearable device showing the battery percentage after someone set it.

FIG. 12 is a top view of the wearable device showing interval after someone set it.

FIG. 13 is to show how the system works.

### REFERENCE NUMERALS IN THE DRAWINGS

For a more complete understanding of the present invention parts, reference is now made to the following descriptions:

100. The wearable device.

### 102. Strape.

104. Insertion holes.
106. Free loop.

### 108. Buckle.

### 110. Nail.

### 112. Head.

### 114. Display.

116. First button.
118. Second button.
120. USB charging port.
122. Battery percentage.

### 124. Intervals.

### 126. Someone.

### 128. Anchor.

### 130. Focus-repetition.

132. Charger cable.
134. The caved part of the strap.
136. Choose a goal.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawings, like numbers refer to like elements throughout, and thicknesses and dimensions of some components may be exaggerated for providing better clarity and ease of understanding.

Moreover, although the following description contains many specifics for the purposes of illustration, anyone skilled in the art will appreciate that many variations and/or alterations to said details are within the scope of the present technology. Similarly, although many of the features of the present technology are described in terms of each other, or in conjunction with each other, one skilled in the art will appreciate that many of these features can be provided independently of other features. Accordingly, this description of the present technology is set forth without any loss of generality to, and without imposing limitations upon, the present technology.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced items.

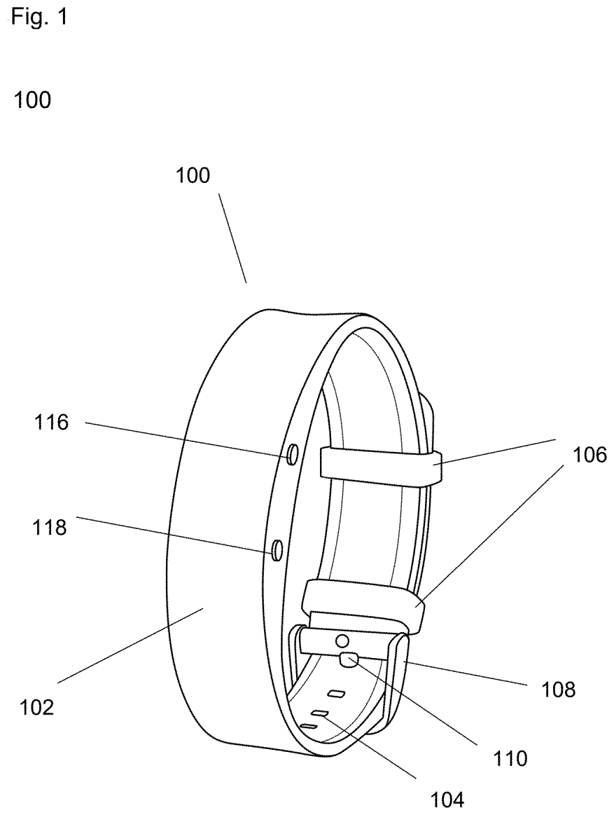

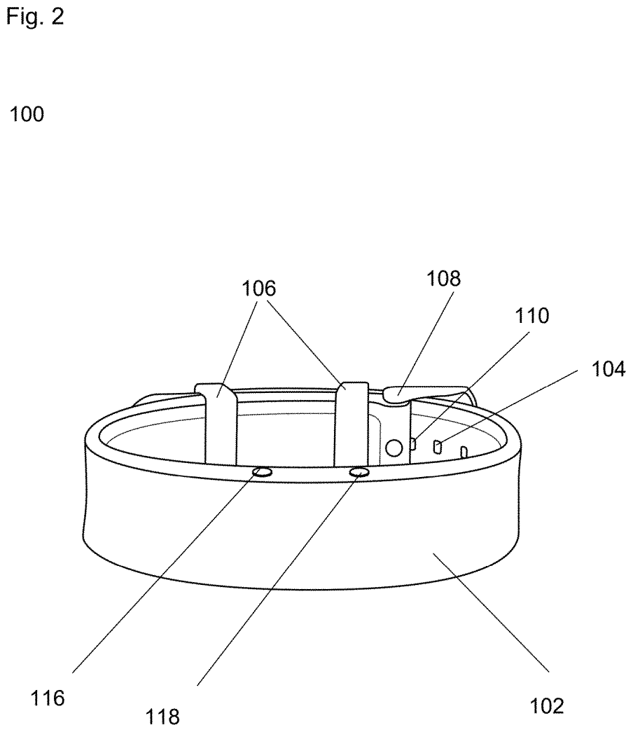

Referring to FIG. 1 and FIG. 2, the main parts of the wearable device 100 are the strap 102 that is inserted in the buckle 108 by inserting the nail 110 inside the insertion holes 104 then insert it in the free loops 106, also we can see the first button 116 and the second button 118.

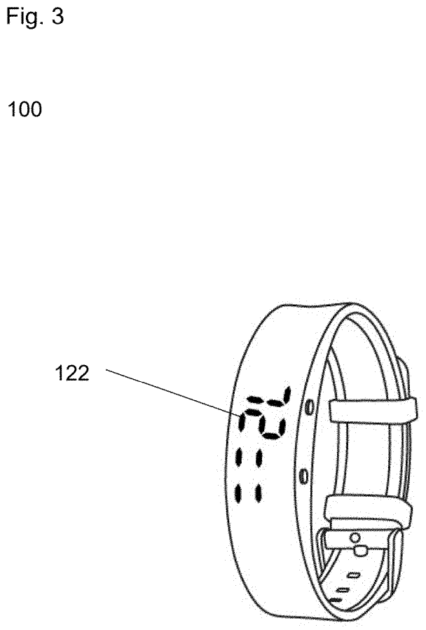

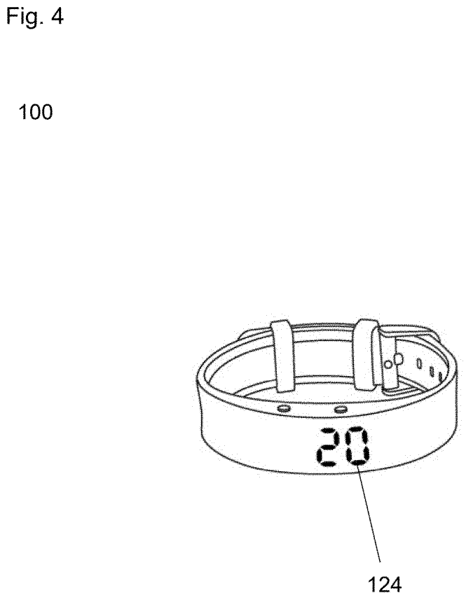

Referring to FIG. 3 this is a perspective top side view of the wearable device 100 showing the battery percentage 122. And referring to FIG. 4 this is a perspective top side view of the wearable device 100 showing the intervals 124.

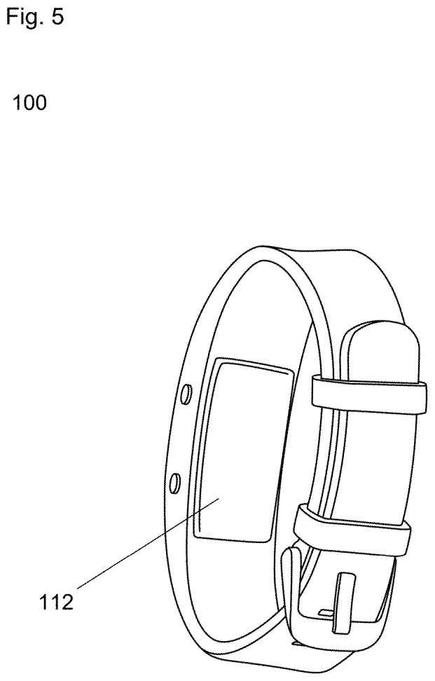

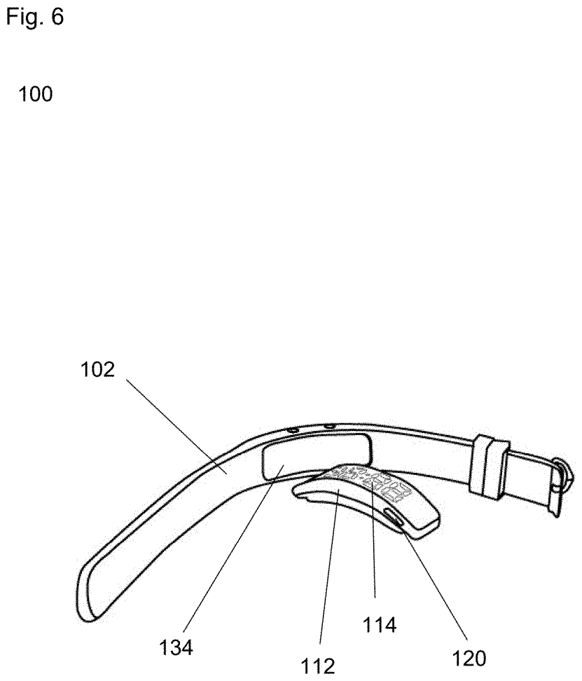

To show the rest of the main parts of the wearable device 100, as shown in FIG. 5, this is a perspective bottom side view of the wearable device 100 showing the head 112 that is including the display 114 and USB charging port 120 as shown in FIG. 6, also, referring to FIG. 6, the head 112 can be taken off from the strap 102 and installed inside the caved part of the strap 134 to protect it. The display 114 is to show the battery percentage 122 as shown in FIG. 3 and interval 124 as shown in FIG. 4, and the numbers can be seen after the head 112 installed inside the caved part of the strap 134 as the caved part of the strap 134 is thin.

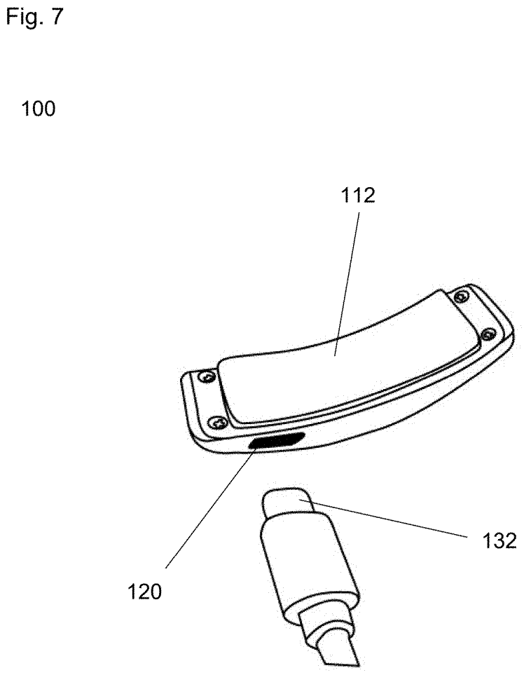

Referring to FIG. 7, to charge the wearable device 100, we put the charger cable 132 inside the USB charging port 120 of the head 112.

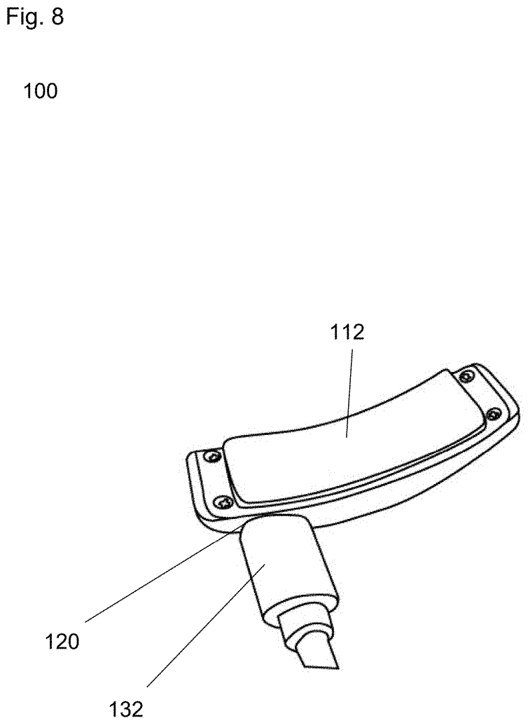

Referring to FIG. 8, this is a perspective bottom view of the head 112 showing the charger cable 132 after installed inside the USB charging port 120.

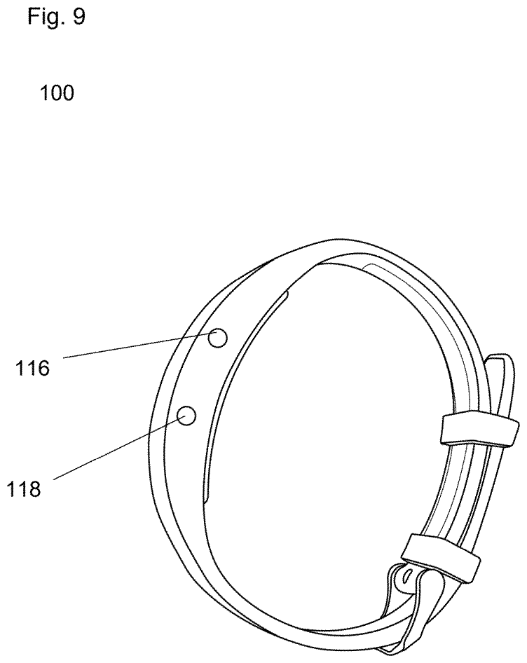

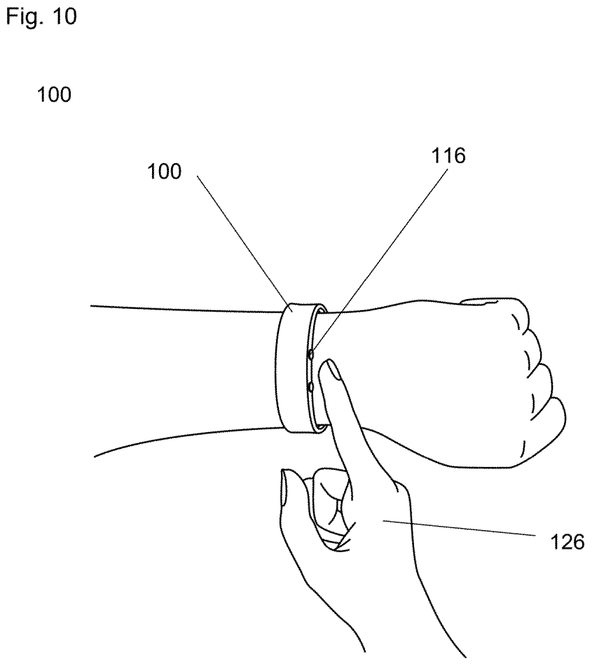

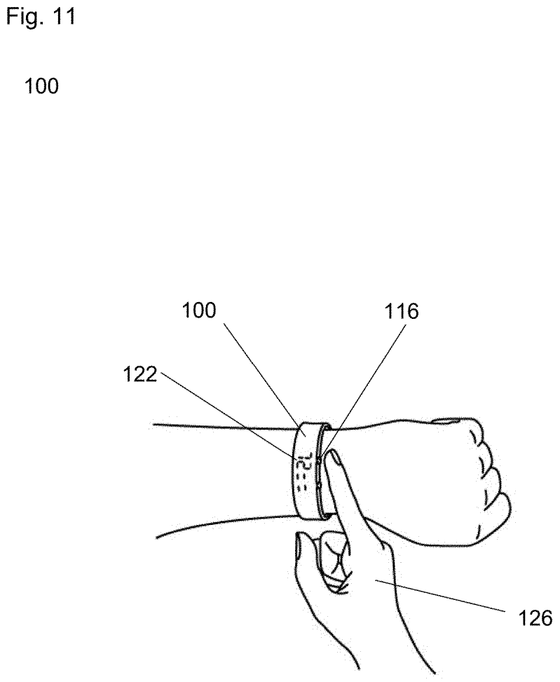

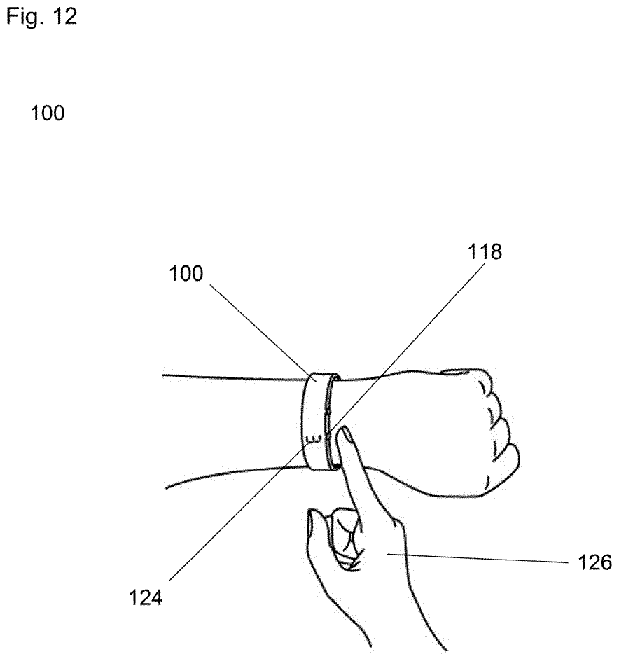

Referring to FIG. 9, these are the first button 116 and the second button 118 someone 126 can use them as shown in FIG. 10 to know the battery percentage 122 as shown in FIG. 11 and set intervals 124 as shown in FIG. 12.

Referring to FIG. 10, when someone 126 likes to turn the wearable device 100 off or turn the wearable device 100 on, he long presses the first button 116.

Referring to FIG. 11, when someone 126 likes to know the battery percentage 122 of the wearable device 100, he presses on the first button 116.

Referring to FIG. 12, when someone 126 likes to set the wearable device 100 to remind him to take an action for a specific goal, he presses on the second button 118 to choose the interval 124 of the reminder.

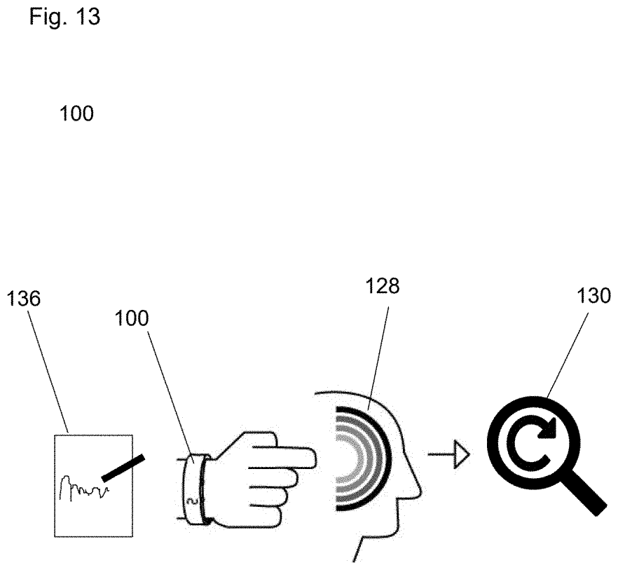

Referring to FIG. 13, this is to explain the method used with the wearable device 100, the wearable device 100 of the current invention helps us to use focus-repetition to keep our goals and intentions at the forefront of our mind, the long focus-repetition by the wearable device 100 will compel us to take the actions we need to achieve our goals or convert them into habits.

The subconscious mind doesn't distinguish the difference between what we imagine to be happening and what is actually happening, so that we can get ourselves in a state simply by thinking about the goal we want to reach, and by using focus-repetition using the wearable device 100 of the present invention, we can reach our goals.

As shown in FIG. 13, to make the most out of the wearable device 100 of the present invention, we use it with these steps:

### 1—Chose a Goal 136

In this step, we chose one goal only to help the mind to focus on it.

### 2—Set the Wearable Device 100

In this step, as shown in FIG. 12, by using the second button 118, we set the time interval 124 to specify how many times we want the wearable device 100 to send vibrated reminders.

### 3—Anchor 128

In this step we mentally connect the goal to the vibrated reminders we receive from the wearable device 100, so, whenever we feel the vibration, we think about the specified goal and the action needed to reach that goal automatically.

### 4—Focus-Repetition 130

In this step, by the help of the vibrated reminders we receive from the wearable device, our conscious mind receive a message that our specified goal is a top priority and it must do everything to reach it, and the continuation of receiving the vibrated reminders will keep this goal on the top priority of mind without holding back as a result of receiving new thoughts everyday. Also, the subconscious mind receives a message that this goal has already been achieved and this will summon all the mind abilities to reach this goal.

Although the present disclosure has been explained in relation to its preferred embodiment(s) as mentioned above, it is to be understood that many other possible modifications and variations can be made without departing from the spirit and scope of the inventive aspects of the present invention. It is, therefore, contemplated that the appended claim or claims will cover such modifications and variations that fall within the true scope of the invention.

What is claimed is:

1. A system to remind people to take an action to achieve their goals and form new habits by using the power of their focus and repetition comprising;
a wearable vibrating device to provide automatic reminders at pre-selected intervals to remind a user to perform an action to achieve his goal; and,
a method comprising the steps of;
choose a one goal to help the mind to focus on it;
select a time interval from the wearable device;
mentally connect the vibrated reminder the user receives from the wearable device to an action he must to do to achieve the goal, so that when the user feels the vibration, they think about the chosen action and goal automatically;
focus-repetition where when a user receives the vibrated reminder, the user takes a deep breath, observes his thoughts, puts attention on in his goal to make the user conscious mind receives a message that specified goal is a top priority and a user must do everything to reach it, and the continuation of receiving the vibrated reminders will keep specified goal on the top priority of mind, and the subconscious mind receives a message that this goal has already been achieved as the subconscious mind doesn't distinguish between what we imagine and what is actually happening which will lead to summon all the mind abilities to reach this goal.

2. the wearable device of claim 1 comprising:
strap;
insertion holes;
free loop;
buckle;
nail;
caved part of the strap;
head;
display;
first button;
second button; and,
USB charging port.

3. The wearable device of claim 1 and claim 2 wherein to close the strap around the wrist, a user inserts the strap in the buckle by inserting the nail inside the insertion holes then inserts the strap in the free loops.

4. The wearable device of claim 1 and claim 2 wherein the strap has a caved part to install the head to protect it.

5. The head of the wearable device of claim 1 and claim 2 including a display, a first button, a second button and a USB charging port.

6. The USB charging port of claim 2 and claim 5 is to charge the wearable device using a USB charging cable.

7. The display of claim 2 and claim 5 is to show the battery percentage and interval numbers after the head is inserted inside the caved part of the strap as the caved part of the strap is thin, so the LED light of the display shines through and is visible.

8. The first button of claim 2 and claim 5 wherein a user long presses to turn the wearable device off or turn the wearable device on.

9. The first button of claim 2 and claim 5 wherein a user presses to see the battery percentage on the screen.

10. The second button of claim 2 and claim 5 wherein a user presses to choose the interval of a reminder to connect and remind him to take an action to reach a specific goal.

11. The wearable device of claim 1 is not annoying wherein the wearable device vibrates for 4.5 seconds and does not need to be pressed.

12. The system of claim 1 can help with creating good habits and reach goals as it helps to keep our goals at the forefront of mind, as the system helps users to feel motivated to take action toward achieving goals or forming new habits.

13. The system of claim 1 wherein the wearable device gives a vibration reminder that focuses your mind and keeps your goal in your conscious awareness and prompts to take action.

14. The system of claim 1 helps people to focus on their goals only without getting distracted.

15. The system of claim 1 mentally connects the vibrated reminders to a specific action required to reach a goal.

16. The wearable device of claim 1 vibrates throughout the day to remind a user to focus on and reach their behaviour change goal.

17. The wearable device of claim 1 has no apps to avoid distracting users.

18. The system of claim 1 uses focus-repetition with a physical action by sending user a steady stream of vibrated reminders flooding through the user mind to achieve a specific goal, leading user to take an action, and the wearable device floods the users subconscious mind with their intention, and through repetition, the goal can become a muscle memory habit.

19. The system of claim 1 helps to keep the feeling a user had when a user planned to achieve a goal, at the front of the user mind, in order to keep the user motivated to achieve his goal.
